(19) United States
(12) Patent Application Publication
(10) Pub. No.: US 2018/0232566 A1
(43) Pub. Date: Aug. 16, 2018

(54) ENABLING FACE RECOGNITION IN A COGNITIVE COLLABORATION ENVIRONMENT

(71) Applicant: Cisco Technology, Inc., San Jose, CA (US)

(72) Inventors: Keith Griffin, Co. Galway (IE); Vesselin Kirilov Perfanov, Oslo (NO)

(21) Appl. No.: 15/804,177

(22) Filed: Nov. 6, 2017

Related U.S. Application Data
(60) Provisional application No. 62/459,176, filed on Feb. 15, 2017.

(51) Int. Cl. G06K 9/00; G06F 17/30

(52) U.S. Cl. CPC G06K 9/00288; G06F 17/30256; G06K 9/00255

(57) ABSTRACT

A method including obtaining a vector including a plurality of numbers representative of a face of a user of a collaboration endpoint, wherein the vector is generated from the face captured by a camera of the collaboration endpoint; identifying an identity of the face of the user using the vector; and based on the identity of the face of the user, causing a collaboration action to be performed at the collaboration endpoint is disclosed.

### PRIORITY CLAIM

This application claims priority to U.S. Provisional Application No. 62/459,176, filed Feb. 15, 2017, the entirety of which is incorporated herein by reference.

### TECHNICAL FIELD

The present disclosure relates to performing a collaboration action based on an identity of a collaboration endpoint user.

### BACKGROUND

Collaboration (e.g., video conference) systems enable video and audio communication between users at remote locations. There are numerous ways to initiate a video conference session, and the use of facial recognition of users has been explored. The use of facial recognition data presents security risks, such as that the image of the face may be intercepted when it is transmitted from the local collaboration endpoint to the remote server.

### BRIEF DESCRIPTION OF THE DRAWINGS

FIG. 1 is a block diagram illustrating a system for recognizing faces of users of a collaboration system, according to an example embodiment.

FIG. 2 is a block diagram of a collaboration endpoint configured to participate in the facial recognition techniques presented herein, according to an example embodiment.

FIG. 3 is an image of a face of a user at a collaboration endpoint with facial feature overlays to illustrate aspects of the facial recognition techniques, according to an example embodiment.

FIG. 4 illustrates a use of a classifier-based process in the facial recognition techniques, according to an example embodiment.

FIG. 5 illustrates a use of a descriptor-based process in the facial recognition techniques, according to an example embodiment.

FIGS. 6A and 6B illustrate a process to train a descriptor network as part of the facial recognition techniques, according to an example embodiment.

FIG. 7 illustrates an identity database containing a plurality of facial vectors and a plurality of associated identities, according to an example embodiment.

FIG. 8 illustrates a flow of communications to perform the facial identification and collaboration actions, according to an example embodiment.

FIG. 9 illustrates a flowchart of a method to identify a user and cause a collaboration action based on the identified user, according to an example embodiment.

FIG. 10 illustrates a block diagram of a computing device configured to identify a face and cause a collaboration action, according to an example embodiment.

### DESCRIPTION OF EXAMPLE EMBODIMENTS

### Overview

Presented herein are techniques for identifying a face of a user at a collaboration endpoint and causing a collaboration action to be performed based on the identity of the face of the user. More specifically, in accordance with the techniques presented herein, a vector including a plurality of numbers may be obtained. The vector is representative/descriptive of the face of the user at the collaboration endpoint. Moreover, the vector is generated from an image of the face captured by a camera of the collaboration endpoint. The vector may then be used to identify the face of the collaboration endpoint. Based on the identity of the face, a collaboration action may be caused to be performed at the collaboration endpoint.

### Example Embodiments

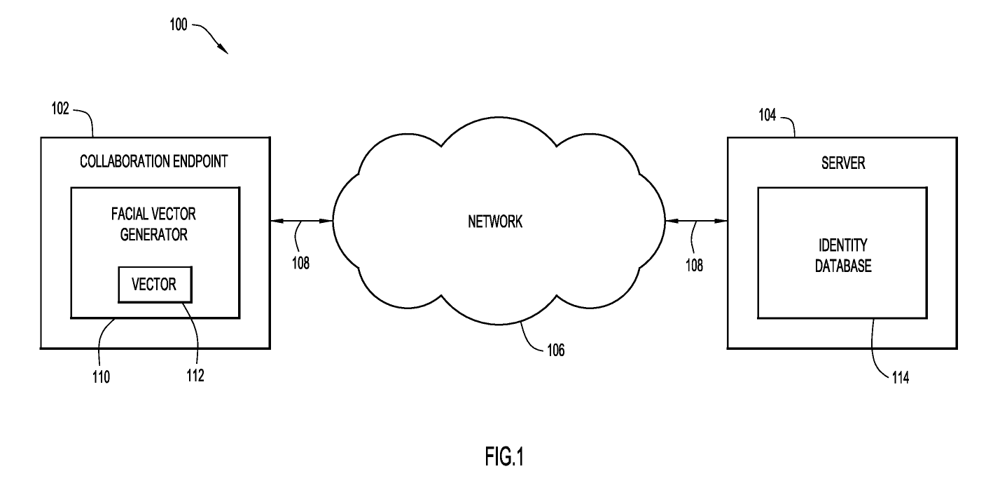

Referring first to FIG. 1, shown is a system 100 for recognizing faces of users of a collaboration system, according to an example embodiment. For ease of illustration, FIG. 1 illustrates one collaboration endpoint 102. However, it is to be appreciated that the techniques presented herein may be implemented in systems that include more than one collaboration endpoint.

The collaboration endpoint 102 is connected to a server 104 via a network 106. The collaboration endpoint 102 and the server 104 may be connected to the network 106 via communication links 108. The network 106 may be a local area network (LAN), a wireless local area network (WLAN), a wide area network (WAN), or a metropolitan area network (MAN), etc. As shown, the collaboration endpoint 102 and the server 104 are connected to the network 106 via a respective communication link 108. The communication links 108 may be wired communication links, wireless communication links, or a combination of wired and wireless communication links.

The collaboration endpoint 102 includes a facial vector generator 110 that is configured to perform the facial recognition techniques presented herein. More specifically, the facial vector generator 110 is configured to generate a vector 112 that is representative/descriptive of a face of a user of the collaboration endpoint 102. The collaboration endpoint 102 transmits the vector 112 to the server 104, which uses the vector 112 to identify the face of the user. The server 104 then transmits the identity to the collaboration endpoint 102, which may perform a collaboration action based on the received identity.

The server 104 includes an identity database 114. The identity database 114 may include a mapping of identities to vectors as described above. The identity database 114 may include a plurality of vectors. The plurality of vectors represent a plurality of faces in images. Each vector is associated with a face. Additionally, the identity database 114 may also include a plurality of names. Each of the names is associated with a vector and face combination. The methods by which the vectors are generated are described in more detail below.

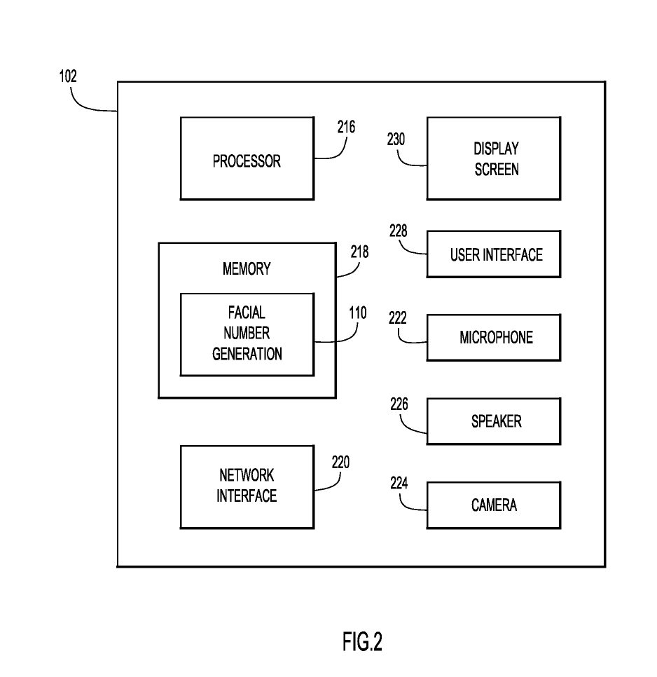

Turning next to FIG. 2, shown is a block diagram of collaboration endpoint 102 of FIG. 1. As shown, collaboration endpoint 102 includes a processor 216, a memory 218, a network interface 220, a microphone 222, a camera 224, a speaker 226, a user interface 228, and a display screen 230. The memory 218 includes the facial vector generator 110.

The display screen 230 is an output device, such as a liquid crystal display (LCD), for presentation/display of visual information or content to users. The content displayed at the display screen 230 may comprise, for example, data content (e.g., a PowerPoint presentation, a portable document format (PDF) file, a Word document, etc.), video content (e.g., video from cameras captured at a remote collaboration endpoint), notifications (e.g., a notification that a new user has joined the collaboration session or an existing user has left the collaboration session), images, etc. While the display screen 230 is described in terms of displaying data content, video content, and notifications, it is to be appreciated that the content may be various objects in various formats. Moreover, the content may include the simultaneous display of multiple objects in multiple different formats.

The user interface 228 may take many different forms and may include, for example, a keypad, keyboard, mouse, touchscreen, etc. In certain examples in which the user interface 228 is a touchscreen, the display screen 230 and the user interface 228 may be integrated as a single unit that both accepts inputs from a user of the collaboration endpoint 102 and displays content.

In the example of FIG. 2, the microphone 222 is a device that is configured to detect acoustic signals (e.g., voices of persons) and to convert the acoustic signals into electrical signals. While one microphone 222 is described in FIG. 2, any number of microphones may be used in the collaboration endpoint 102.

The collaboration endpoint 102 also comprises a camera 224. The camera 224 is configured to capture and/or record video, such as video of persons. The camera 224 is also configured to capture images, such as images of faces of persons using the collaboration endpoint 102. The captured images of faces may be used to identify the faces as described further below.

The memory 218 includes the instructions for the facial vector generator 110. As described further below, the instructions for the facial vector generator 110 may be executed by the processor 216 to perform measurements and generate a vector that enable the server 104 (FIG. 1) to determine the identity of the face captured in the image. The memory 218 may comprise any one or more of read only memory (ROM), random access memory (RAM), magnetic disk storage media devices, optical storage media devices, flash memory devices, electrical, optical, or other physical/tangible memory storage devices. The one or more processors 216 are, for example, microprocessors or microcontrollers that execute instructions for the facial vector generator 110 stored in memory 216.

The collaboration endpoint 102 may also include a network interface 228. The network interface 228 enables the collaboration endpoint 102 to transmit and receive network communications. For example, the network interface 228 enables the collaboration endpoint 102 to transmit network traffic to the server 104 via the network 106 and communication links 108. Additionally, the network interface 228 may enable the collaboration endpoint 102 to receive network traffic from the server 104 via the network 106 and communication links 108.

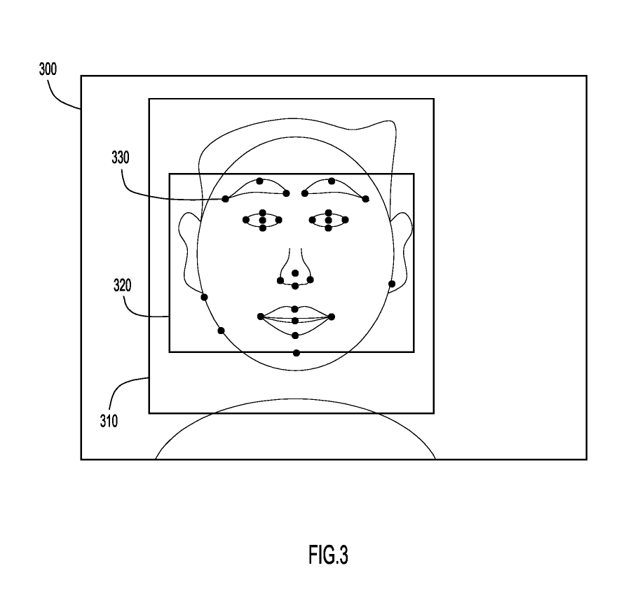

Turning to FIG. 3, with continuing reference to FIGS. 1 and 2, shown is an image 300 of a face of a user of the collaboration endpoint 102 with facial feature overlays, according to an example embodiment. The image 300 includes a first overlay 310, a second overlay 320, and a plurality of facial feature points 330. The image 300 may be a result of an image captured by the camera 222 and processed by the facial vector generator 110, for example. The image 300 has been processed by the facial vector generator 110 to generate the first and second overlays 310 and 320 and the plurality of facial feature points 330. For example, the facial vector generator 110 may use a neural network, such as a convolutional neural network or a dynamic neural network, to generate the first and second overlays 310 and 320 and the plurality of facial feature points 330, as described in more detail below. The facial vector generator 110 may generate values for the vector 112 using the first and second overlays 310 and 320 and the plurality of facial feature points 330. The facial vector generator 110 may use a combined classifier and descriptor process to classify the image and to generate the values for the vector 112, as described in more detail below.

The combined classifier and descriptor process may generally be referred to as a two-step process. The classifier-based process may be the first step and the descriptor-based process may be the second step. Generally, the classifier-based process classifies elements in an image, such as image 300. The descriptor-based process may generate measurements based on the classified elements in the image. These measurements may then be used as values in the vector 112 that represents the face in the image.

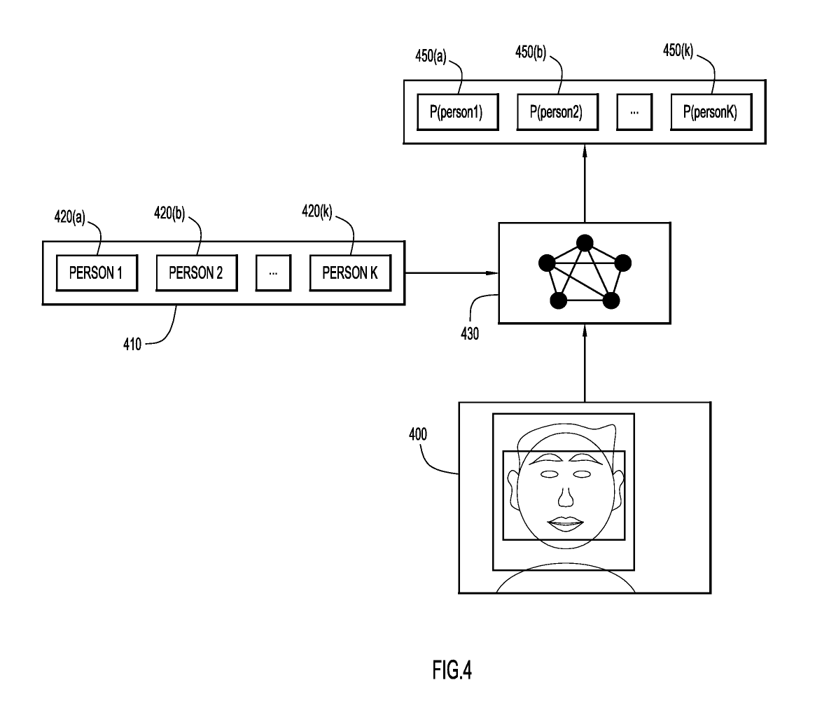

More specifically, turning to FIG. 4, with continuing reference to FIG. 3 as well as FIG. 2, shown is a use of a classifier-based process, according to an example embodiment. The classifier-based process may be computer-executable instructions that are a part of the facial vector generator 110. Image 400 may be the image captured by the camera 222 before it is processed by the facial vector generator 110 to generate overlays and a plurality of facial feature points. The image 400 and a training set 410 of facial images 420(a), 420(b), 420(k) may be input into neural network 430. The neural network 430 analyzes the image 400 and outputs a probability 450(a), 450(b), 450(k) of the identity of the face in the image 440 corresponds to one of the faces in the training set 410.

The classifier-based process may operate as a first pass analysis of the image 400. For example, the classifier-based process may recognize objects, using the neural network 430, in the image 40. The neural network 430 is trained using conventional computer vision-based classifying techniques. For example, the classifier-based process may recognize that there is a face and classify it as such. The first overlay 310 (shown in FIG. 3) may be classified as a face. The classifier-based process may also classify elements of the face, such as eyes, nose, mouth, etc. Moreover, the classifier-based process may also classify other elements within the image 400, such as glasses, a hat, earrings, etc. A single classifier that is invariant to non-essential facial features, such as glasses, a hat, earrings, etc. may be used. Image 300 (shown in FIG. 3) visually displays results of the operation of the classifier-based process on the image 400.

Based on these classifications, the classifier-based process, using the neural network 430, may output probabilities 450(a), 450(b), 450(k) indicating the probability that each face 420(a), 420(b), 420(k) in the training set 410 is the classified face. In some aspects, the output of the classifier-based process does not identify the face in the image 400. After the classifier-based process ends, the facial vector generator 110 may use the descriptor-based process to further analyze the image 400.

One advantage of using a classifier-based process is that classification and, if implemented, facial recognition are performed very quickly. Additionally, the neural network 430 is easier to train and is more tolerant to an amount of training data. However, for large training sets, using a classifier-based process may be more difficult at the collaboration endpoint 102 because the training set 410 may include tens of thousands of images. Performing a comparison of the image 300 to tens of thousands of images at the collaboration endpoint 102 may require significant hardware resources, which the collaboration endpoint 102 may not have. Therefore, in some aspects of this disclosure, the classifier-based process may be executed by the server 104. In other aspects of this disclosure, the collaboration endpoint 102 and the server 104 may each perform aspects of the classifier-based process.

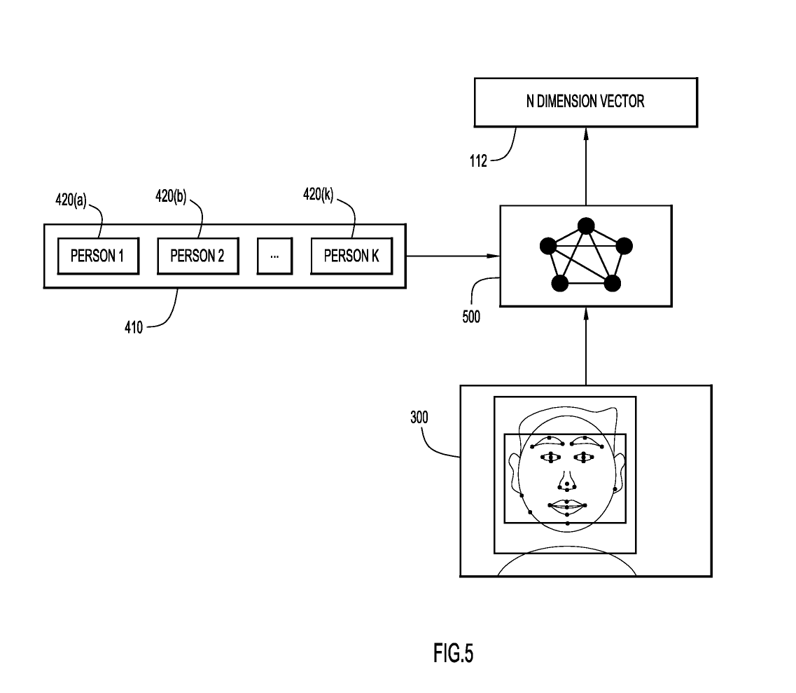

Turning to FIG. 5, shown is the descriptor-based process, according to an example embodiment. Like the classifier-based process, the descriptor-based process may be computer-executable instructions that are a part of the facial vector generator 110. The classified image 300 and the training set 410 of facial images 420(a), 420(b), 420(k) may be input into a neural network 500. The training of the neural network 500 is described in more detail below. The neural network analyzes the classified image and outputs an N dimensional vector. The N dimensional vector may contain N values, where the N values correspond to N measurements taken of the face.

The descriptor-based process may operate as a second pass analysis of the image 300. For example, the descriptor-based process may take measurements of all of the classified objects in the classified image 300. This process may take measurements of, for example, a size of an eye, a distance between eyes, a size of the mouth, etc. The descriptor-based process may process each of the measurements to generate N values for the N dimensional vector 112. Because the N dimensional vector 112 includes values for all classified objects in the face, the N dimensional vector 112 may be treated as a numeric representation of the face.

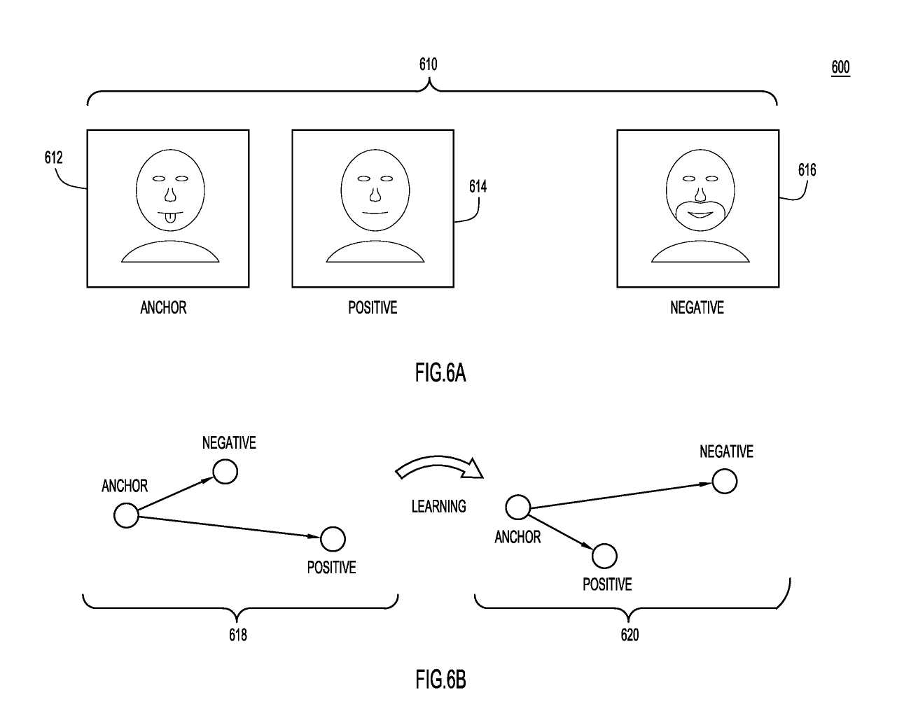

The descriptor-based process depends on a trained descriptor network that is used by the neural network. FIG. 6A illustrates a process 600 to train the descriptor network, according to an example embodiment. In one example, the descriptor network may be trained using a triplet 610, or a 3-tuple, which may be part of the training set 410. The triplet 610 contains three images: an anchor image 12, a positive image 614, and a negative image 616. The anchor image 612 may be a baseline image of a face. For example, the anchor image 612 may be an image of a face of a person from a corporate directory. The positive image 614 may be a second image of the face of the person. The positive image 614 may be different from the anchor image 612. Such differences may include different lighting conditions or the presence or absence of accessories, such as glasses. The negative image 61 is an image of a face of a different person. This triplet 610 may be used to increase the accuracy of the descriptor-based process, in particular, the functioning of the neural network 500 shown in FIG. 5.

Shown in FIG. 6B are graphical representations 618, 620 of training the descriptor network, according to an example embodiment. Graphical representation 618 represents a first configuration of the descriptor network. In graphical representation 618, the descriptor network is configured so that the anchor image 612 is closer to the negative image 616 than the positive image 614. Therefore, in this first configuration, the descriptor network determines that the negative image 616 is more similar to the anchor image 612 than the positive image 614. Accordingly, this first configuration may result in an incorrect analysis. However, as the descriptor network is trained, i.e., as the descriptor network learns, the descriptor network may more accurately analyze an image. Graphical representation 620 is a second configuration of the descriptor network. This second configuration represents the descriptor network after training. In graphical representation 620, the descriptor network is configured so that the anchor image 612 is now closer to the positive image 614 than to the negative image 616. Therefore, in this second configuration, the descriptor network determines that the positive image 614 is more similar to the anchor image 612 than the negative image 616 is. Accordingly, in this second configuration, the descriptor network may more accurately analyze an image.

One advantage of the descriptor-based process is that the descriptor works universally. In other words, the descriptor-based process works for new identities without requiring retraining of the neural network 500. Another advantage is that descriptor-based process is easier than the classifier-based process to port to collaboration endpoint 102. Therefore, the collaboration endpoint 102 may process the image 300 locally without sending images over the network 106, which increases the security of the system.

The classifier and descriptor-based processes have been described as occurring at the collaboration endpoint 102. However, in other example embodiments, the server 104 may also include a facial vector generator 110. In these example embodiments, the server 104 may perform either or both of the classifier-based process and the descriptor-based process.

Referring back to FIG. 1, after the facial vector generator 110 generates the vector 112 representative of the face in the image, an identity corresponding to the face may be determined. In this example, the facial vector generator 110 generates the vector 112 at the collaboration endpoint 102. However, the collaboration endpoint 102 does not include the identity database 114. Instead, the identity database 114 is located at the server 104. Therefore, the collaboration endpoint 102 transmits the vector 112 to the server 104 for identification.

Transmitting the vector 112, rather than the image 440, to the server 104 for identification results in a number of advantages. One advantage is increased security. Because the techniques of this disclosure transmit a vector 112 instead of the image 440, if the data were to be intercepted, there would be less security vulnerability because only the vector 112, rather than the image 440, is intercepted. Another advantage is that the scale of the network 106 may be improved. This is so the identification processing is split between the collaboration endpoint 102 and the server 104. The collaboration endpoint 102 may analyze the image 440 and generate the vector 112 representative of the face in the image 400. By transmitting the vector 112 to the server 104, the collaboration endpoint 102 does not need to perform processing-intensive tasks such as identifying who is represented by the vector 112. Instead, the server 104, which may be capable of performing such processing-intensive tasks, performs that function.

Once the server 104 receives the vector 112, the server 104 may resolve the identity of the person whose face is represented by the vector 112. The server 104 may include the identity database 114, as described in more detail below.

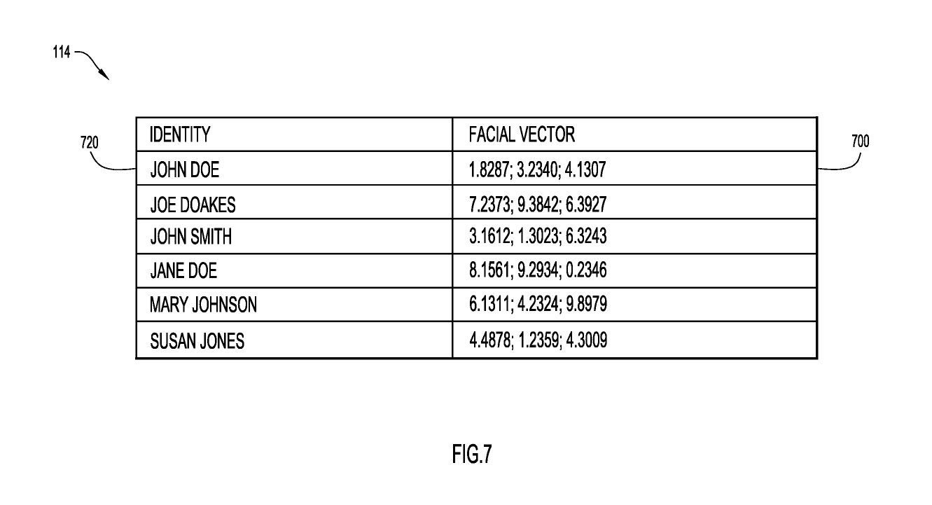

Turning to FIG. 7 with continued reference to FIG. 1, shown is an example the identity database 114 containing a plurality of facial vectors 700 and a plurality of associated identities 720, according to an example embodiment. While the identity database 114 in FIG. 7 only contains six entries, it should be appreciated that any number of entries may be included in the identity database 114. The plurality of facial vectors 700 may be generated using the combined classifier and descriptor-based processes described above. For the identity database 114, an identity of the person with the face in the image is associated with the facial vector. After the server 104 receives the vector 112 from the collaboration endpoint 102, the server 104 may perform a lookup in the identity database 114. The facial vector in the identity database 114 that is closest to the vector 112 received from the collaboration endpoint 102 is selected as the matching facial vector. The identity associated with the matching facial vector may be transmitted to the collaboration endpoint 102.

At the collaboration endpoint 102, after receiving the identity from the server 104, the collaboration endpoint 102 may cause a collaboration action to be taken based on the received identity. For example, the identified person may have an upcoming collaboration session. The collaboration endpoint 102 may query the identified person if he/she would like to begin the collaboration session. It should be appreciated that other collaboration actions, such as collaboration session roster generation, active speaker recognition, etc. may be caused as well.

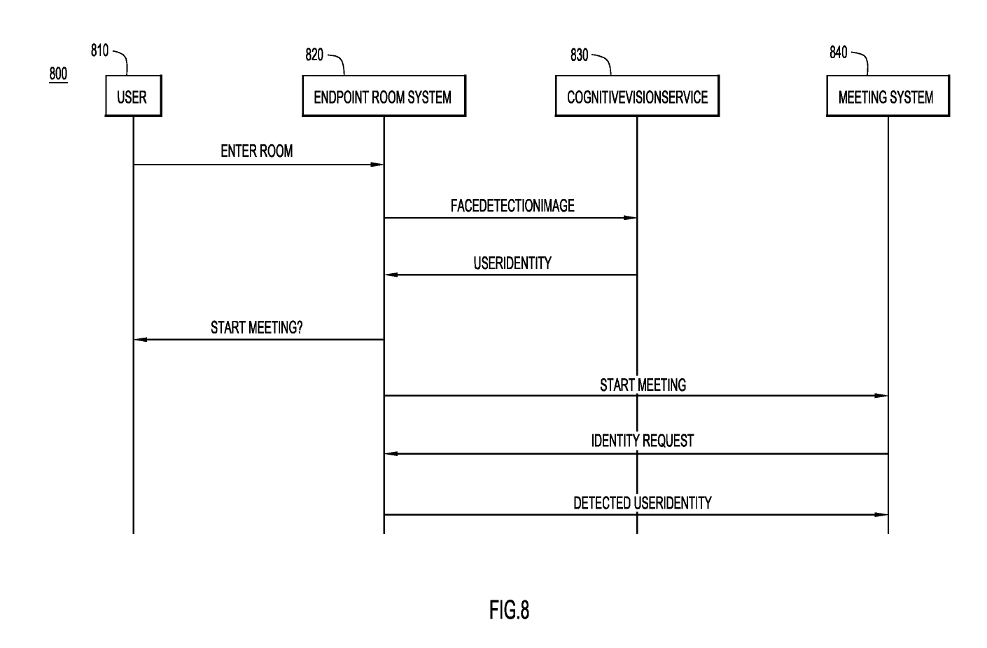

Turning to FIG. 8, shown is a flow of communications 800 to perform the facial identification and collaboration actions of the techniques of this disclosure, according to an example embodiment. Reference is also made to FIG. 1 for purposes of the description of FIG. 8. The collaboration action shown in FIG. 8 is a meeting start. FIG. 8 illustrates a user, which may be a meeting participant, an endpoint room system, which may be the collaboration endpoint 102, a cognitive vision service, which may be executed on either the collaboration endpoint 102 or server 104, and a meeting system, which may be embodied by the server 104.

The user 810 may enter a room that includes the endpoint room system 820. The endpoint room system 820 may capture an image of the user 810 and transmit the image to the cognitive vision service 830. The cognitive vision service 830 may identify the identity of the user 810 and returns the identity to the endpoint room system 820. Based on the received identity, the endpoint room system 820 may prompt the user 800 if the user 810 wishes to start the meeting. When the user 810 indicates that the user 810 wishes to start the meeting, the endpoint room system 820 may transmit a start meeting message to the meeting system 840. The meeting system 840 transmits an identity request to the endpoint room system 820, which may reply with the identity of the user 820 received from the cognitive vision service 830. The meeting may then begin.

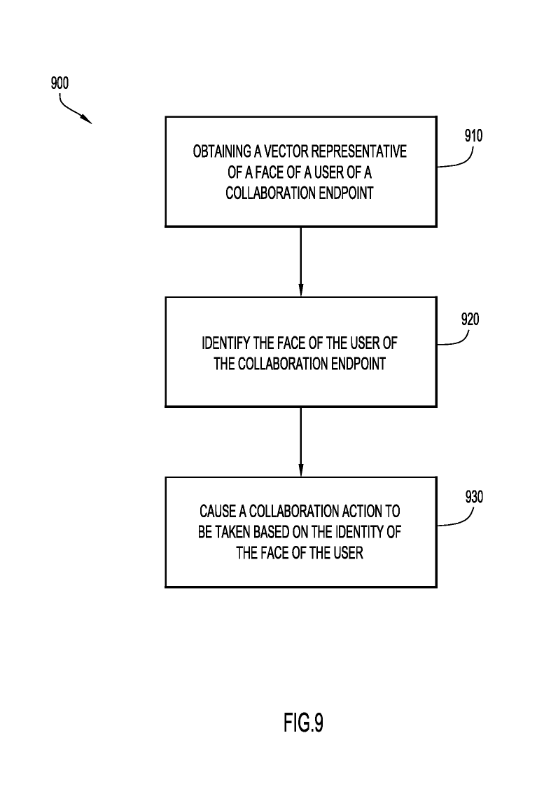

Turning to FIG. 9, shown is a flowchart of method 900 to identify a user and cause a collaboration action based on the identified user, according to an example embodiment. The method 900 may begin at operation 910. At operation 910, a vector representative of a face of a user of a collaboration endpoint may be obtained. The vector may be generated from the face of an image captured by a camera of the collaboration endpoint. The vector may be generated using, for example, the classifier and descriptor-based processes as described above.

At operation 920, the identity of the face captured by the camera may be determined. For example, the identity may be determined using an identity database.

At operation 930, a collaboration action may be caused based on the identity of the user at the collaboration endpoint 102. For example, the collaboration action may be starting a collaboration session, generating a collaboration session roster, and active speaker recognition during a collaboration session.

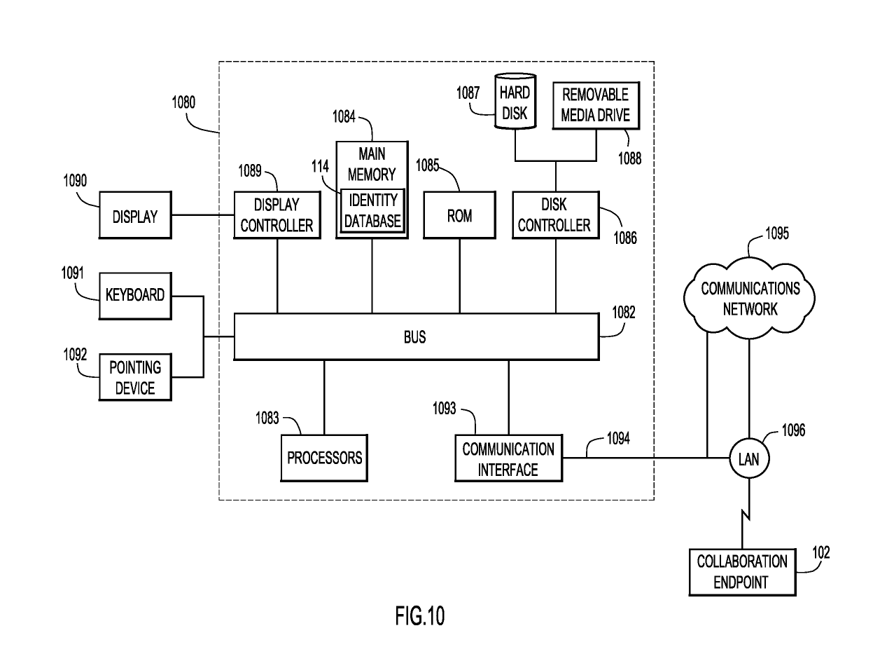

Turning to FIG. 10, shown is a block diagram of a computing device that may be representative of server 104 shown in FIG. 1, configured identify a face and cause a collaboration action based on the identifying, according to an example embodiment. FIG. 10 illustrates a computer system 1080 upon which the embodiments presented may be implemented. The computer system 1080 includes a bus 1082 or other communication mechanism for communicating information, and a processor 1083 coupled with the bus 1082 for processing the information. While the figure shows a single block 1083 for a processor, it should be understood that the processors 1083 represent a plurality of processing cores, each of which can perform separate processing. The computer system 1080 also includes a main memory 1084, such as a random access memory (RAM) or other dynamic storage device (e.g., dynamic RAM (DRAM), static RAM (SRAM), and synchronous DRAM (SD RAM)), coupled to the bus 1082 for storing information and instructions to be executed by processor 1083. In addition, the main memory 1084 may be used for storing temporary variables or other intermediate information during the execution of instructions by the processor 1083. Moreover, the main memory 1084 may also be used for storing the identity database 114, which may be executed by the processor 1083.

The computer system 1080 further includes a read only memory (ROM) 1085 or other static storage device (e.g., programmable ROM (PROM), erasable PROM (EPROM), and electrically erasable PROM (EEPROM)) coupled to the bus 1082 for storing static information and instructions for the processor 1083.

The computer system 1080 also includes a disk controller 1086 coupled to the bus 1082 to control one or more storage devices for storing information and instructions, such as a magnetic hard disk 1087, and a removable media drive 1088 (e.g., floppy disk drive, read-only compact disc drive, read/write compact disc drive, compact disc jukebox, tape drive, and removable magneto-optical drive). The storage devices may be added to the computer system 1080 using an appropriate device interface (e.g., small computer system interface (SCSI), integrated device electronics (IDE), enhanced-IDE (E-IDE), direct memory access (DMA), or ultra-DMA).

The computer system 1080 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 1080 may also include a display controller 1089 coupled to the bus 1082 to control a display 1090, such as a liquid crystal display (LCD), light emitting diode (LED) display, for displaying information to a computer user. The computer system 1080 includes input devices, such as a keyboard 1091 and a pointing device 1092, for interacting with a computer user and providing information to the processor 1083. The pointing device 1092, for example, may be a mouse, a trackball, or a pointing stick for communicating direction information and command selections to the processor 1083 and for controlling cursor movement on the display 1090.

The computer system 1080 performs a portion or all of the processing steps of the process in response to the processor 1083 executing one or more sequences of one or more instructions contained in a memory, such as the main memory 1084. Such instructions may be read into the main memory 1084 from another computer readable medium, such as a hard disk 1087 or a removable media drive 1088. One or more processors in a multi-processing arrangement may also be employed to execute the sequences of instructions contained in main memory 1084. In alternative embodiments, hard-wired circuitry may be used in place of or in combination with software instructions. Thus, embodiments are not limited to any specific combination of hardware circuitry and software.

As stated above, the computer system 1080 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 1080, for driving a device or devices for implementing the process, and for enabling the computer system 1080 to interact with a human user (e.g., print production personnel). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 1080 also includes a communication interface 1093 coupled to the bus 1082. The communication interface 1093 provides a two-way data communication coupling to a network link 1094 that is connected to, for example, a local area network (LAN) 1095, or to another communications network 1096 such as the Internet. For example, the communication interface 1093 may be a wired or wireless network interface card to attach to any packet switched (wired or wireless) LAN. As another example, the communication interface 1093 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1093 sends and receives electrical, electromagnetic or optical signals that carry digital data streams representing various types of information.

The network link 1094 typically provides data communication through one or more networks to other data devices. For example, the network link 1094 may provide a connection to another computer through a local area network 1095 (e.g., a LAN) or through equipment operated by a service provider, which provides communication services through a communications network 1096. The local network 1094 and the communications network 1096 use, for example, electrical, electromagnetic, or optical signals that carry digital data streams, and the associated physical layer (e.g., CAT 5 cable, coaxial cable, optical fiber, etc.). The signals through the various networks and the signals on the network link 1094 and through the communication interface 1093, which carry the digital data to and from the computer system 1080 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1080 can transmit and receive data, including program code, through the network(s) 1095 and 1096, the network link 1094 and the communication interface 1093. Moreover, the network link 1094 may provide a connection through a LAN 1095 to a collaboration endpoint 102 such as a video conferencing system, personal digital assistant (PDA) laptop computer, or cellular telephone.

In one aspect of this disclosure, a method is provided comprising: obtaining a vector including a plurality of numbers representative of a face of a user of a collaboration endpoint, wherein the vector is generated from an image of the face captured by a camera of the collaboration endpoint; identifying an identity of the face of the user using the vector; and based on the identity of the face of the user, causing a collaboration action to be performed at the collaboration endpoint is disclosed.

In another example embodiment, an apparatus is provided including a communication interface configured to enable network communications; and a processor coupled with the communication interface, the processor configured to: obtain a vector including a plurality of numbers representative of a face of a user of a collaboration endpoint, wherein the vector is generated from an image of the face captured by a camera of the collaboration endpoint; identify an identity of the face of the user using the vector; and based on the identity of the face of the user, cause a collaboration action to be performed at the collaboration endpoint is disclosed.

In yet another embodiment, a non-transitory computer-readable storage media is provided that is encoded computer executable instructions that, when executed by a processor, cause the processor to perform operations including obtaining a vector including a plurality of numbers representative of a face of a user of a collaboration endpoint, wherein the vector is generated from an image of the face captured by a camera of the collaboration endpoint; identifying an identity of the face of the user using the vector; and based on the identity of the face of the user, causing a collaboration action to be performed at the collaboration endpoint is disclosed.

The vector may be transmitted from the collaboration endpoint to a server and the collaboration endpoint may receive the identity of the face of the user from the server.

Another aspect of this disclosure includes capturing, at the collaboration endpoint, an image including the face of the user, generating, at the collaboration endpoint, the vector corresponding to the face of the user in the image using a classifier and a descriptor, and generating a single number from the vector.

In another example embodiment, the vector is generated at the collaboration endpoint using the classifier to classify parts of the face of the user in the image, generating measurements of the classified parts of the face, and using the descriptor to generate the plurality of numbers corresponding to the face for the measurements.

In another embodiment, identifying the face includes generating, at a server, a database of a plurality of faces and an identity associated with each of the plurality of faces, and generating a second vector for each of the plurality of faces.

In yet another embodiment, identifying the face includes comparing, at the server, the vector of the face of the user of the collaboration endpoint to the vectors in the database corresponding to each of the plurality of faces, and selecting, at the server, a vector from the vectors corresponding to each of the plurality of faces of the database that is closest to the vector of the face of the user of the collaboration endpoint.

In another aspect, the method of this disclosure includes transmitting the identity corresponding to the selected vector from the server to the collaboration endpoint.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
obtaining a vector including a plurality of numbers representative of a face of a user of a collaboration endpoint, wherein the vector is generated from an image of the face captured by a camera of the collaboration endpoint;
identifying an identity of the face of the user using the vector; and
based on the identity of the face of the user, causing a collaboration action to be performed at the collaboration endpoint.

2. The method of claim 1, wherein identifying further comprises:
transmitting the vector from the collaboration endpoint to a server; and
receiving, at the collaboration endpoint, the identity of the face of the user from the server.

3. The method of claim 1, further comprising:
capturing, at the collaboration endpoint, an image including the face of the user;
generating, at the collaboration endpoint, the vector corresponding to the face of the user in the image using a classifier and a descriptor; and
generating a single number from the vector.

4. The method of claim 3, wherein generating, at the collaboration endpoint, the vector further comprises:
using the classifier to classify parts of the face of the user in the image;
generating measurements of the classified parts of the face; and
using the descriptor to generate the plurality of numbers corresponding to the face for the measurements.

5. The method of claim 1, wherein identifying further comprises:
generating, at a server, a database of a plurality of faces and an identity associated with each of the plurality of faces; and
generating a second vector for each of the plurality of faces.

6. The method of claim 5, wherein identifying further comprises:
comparing, at the server, the vector of the face of the user of the collaboration endpoint to the vectors in the database corresponding to each of the plurality of faces; and
selecting, at the server, a vector from the vectors corresponding to each of the plurality of faces of the database that is closest to the vector of the face of the user of the collaboration endpoint.

7. The method of claim 6, further comprising:
transmitting the identity corresponding to the selected vector from the server to the collaboration endpoint.

8. An apparatus comprising:
a communication interface configured to enable network communications;
a processor coupled with the communication interface, the processor configured to:
obtain a vector including a plurality of numbers representative of a face of a user of a collaboration endpoint, wherein the vector is generated from an image of the face captured by a camera of the collaboration endpoint;
identify an identity of the face of the user using the vector; and
based on the identity of the face of the user, cause a collaboration action to be performed at the collaboration endpoint.

9. The apparatus of claim 8, wherein the processor is further configured to:
transmit the vector from the collaboration endpoint to a server; and
receive, at the collaboration endpoint, the identity of the face of the user from the server.

10. The apparatus of claim 8, wherein the processor is further configured to:
capture, at the collaboration endpoint, an image including the face of the user;
generate, at the collaboration endpoint, the vector corresponding to the face of the user in the image using a classifier and a descriptor; and
generate a single number from the vector.

11. The apparatus of claim 10, wherein the processor is further configured to:
use the classifier to classify parts of the face of the user in the image;
generate measurements of the classified parts of the face; and
use the descriptor to generate the plurality of numbers corresponding to the face for the measurements.

12. The apparatus of claim 8, wherein the processor is further configured to:
generate, at a server, a database of a plurality of faces and an identity associated with each of the plurality of faces; and
generate a second vector for each of the plurality of faces.

13. The apparatus of claim 12, wherein the processor is further configured to:
compare, at the server, the vector of the face of the user of the collaboration endpoint to the vectors in the database corresponding to each of the plurality of faces; and
select, at the server, a vector from the vectors corresponding to each of the plurality of faces of the database that is closest to the vector of the face of the user of the collaboration endpoint.

14. The apparatus of claim 13, wherein the processor is further configured to:
transmit the identity corresponding to the selected vector from the server to the collaboration endpoint.

15. A non-transitory computer-readable storage media encoded computer executable instructions that, when executed by a processor, cause the processor to perform operations including:
obtaining a vector including a plurality of numbers representative of a face of a user of a collaboration endpoint, wherein the vector is generated from an image of the face captured by a camera of the collaboration endpoint;
identifying an identity of the face of the user using the vector; and
based on the identity of the face of the user, causing a collaboration action to be performed at the collaboration endpoint.

16. The computer-readable storage media of claim 15, wherein the identifying operation further comprises:
transmitting the vector from the collaboration endpoint to a server; and
receiving, at the collaboration endpoint, the identity of the face of the user from the server.

17. The computer-readable storage media of claim 15, wherein the operations further comprise:
capturing, at the collaboration endpoint, an image including the face of the user;
generating, at the collaboration endpoint, the vector corresponding to the face of the user in the image using a classifier and a descriptor; and
generating a single number from the vector.

18. The computer-readable storage media of claim 17, wherein the generating, at the collaboration endpoint, the vector operation further comprises:
using the classifier to classify parts of the face of the user in the image;
generating measurements of the classified parts of the face; and
using the descriptor to generate the plurality of numbers corresponding to the face for the measurements.

19. The computer-readable storage media of claim 15, wherein the identifying operation further comprises:
generating, at a server, a database of a plurality of faces and an identity associated with each of the plurality of faces; and
generating a second vector for each of the plurality of faces.

20. The computer-readable storage media of claim 19, wherein the identifying operation further comprises:
comparing, at the server, the vector of the face of the user of the collaboration endpoint to the vectors in the database corresponding to each of the plurality of faces; and
selecting, at the server, a vector from the vectors corresponding to each of the plurality of faces of the database that is closest to the vector of the face of the user of the collaboration endpoint.
